(19) United States
(12) Patent Application Publication
(10) Pub. No.: US 2013/0044820 A1
(43) Pub. Date: Feb. 21, 2013

(54) Method And Apparatus For Coding Data Using Compressive Sampling And Clustering

(71) Applicants: Raziel Haimi-Cohen, Springfield, NJ (US); Hong Jiang, Warren, NJ (US)

(72) Inventors: Raziel Haimi-Cohen, Springfield, NJ (US); Hong Jiang, Warren, NJ (US)

(73) Assignee: ALCATEL-LUCENT USA INC., Murray Hill, NJ (US)

(21) Appl. No.: 13/213,762

(22) Filed: Aug. 19, 2011

(51) Int. Cl. H04N 7/26

(52) U.S. Cl. 375/240.24; 375/E07.075; 375/E07.027

(57) ABSTRACT

Embodiments relate to an apparatus and method for encoding and decoding data. The method includes arranging, by an encoder, data into a plurality of blocks. Each block corresponds to a sub-region of the data. The method further includes assigning, by the encoder, the plurality of blocks into groups such that a spread value associated with each group meets a desired criterion. The spread value indicates a level of dissimilarity or similarity among members of a group. The method further includes generating, by the encoder, a set of measurements for at least one group of blocks. The set of measurements is coded data representing the blocks corresponding to the at least one group.

### BACKGROUND

Currently, protocols used to achieve compression for coding data make it possible to transmit data, such as video data, in real time to end-users within networks. However, such protocols are very sensitive to data loss and corruption. Consequently, even relatively minor losses of data can result in partial video images spanning multiple frames and large spatial regions.

### SUMMARY

Embodiments relate to a method and apparatus for coding data using compressive sampling and clustering.

The method includes arranging, by an encoder, data into a plurality of blocks. Each block corresponds to a sub-region of the data. The method further includes assigning, by the encoder, the plurality of blocks into groups such that a spread value associated with each group meets a desired criterion. The spread value indicates a level of dissimilarity or similarity among members of a group. The method further includes generating, by the encoder, a set of measurements for at least one group of blocks. The set of measurements is coded data representing the blocks corresponding to the at least one group.

In one embodiment, the assigning step assigns one block of the plurality of blocks to two groups.

The method may further include generating, by the encoder, assignment information indicating which blocks belong to which group. In one embodiment, the assignment information includes information indicating an index of a first block and information indicating a plurality of group identifiers. Each group identifier identifies a particular group associated with a block in a sequence of blocks of which said first block is a member. In another embodiment, the assignment information includes information indicating indices of blocks assigned to a respective group.

The method may further include generating at least one datagram of a plurality of datagrams. Each datagram includes the set of measurements for a respective group.

Also, the method may include receiving, by a decoder, assignment information indicating assignments of blocks to a group and a set of measurements representing coded data for the blocks corresponding to the group, and reconstructing, by the decoder, the data for sub-regions corresponding to the blocks of the group based on the set of measurements and the assignment information.

In one embodiment, the receiving step receives at least a portion of the assignment information and the set of measurements in at least one of a plurality of datagrams, and each datagram includes header information which allows the datagram to be parsed independently.

The assignment information includes information indicating an index of a first block and information indicating a plurality of group identifiers. Each group identifier identifies a particular group associated with a block in a sequence of blocks of which said first block is a member. In another embodiment, the assignment information includes information indicating indices of blocks assigned to a respective group.

Embodiments provide an apparatus for encoding data. The apparatus includes an encoder configured to arrange data into a plurality of blocks. Each block corresponds to a sub-region of the data. The encoder is configured to assign the plurality of blocks into groups such that a spread value associated with each group meets a desired criterion. The spread value indicates a level of dissimilarity or similarity among members of a group. The encoder is configured to generate a set of measurements for at least one group of blocks. The set of measurements is coded data representing the blocks corresponding to the at least one group. The encoder may assign one block of the plurality of blocks to two groups.

The encoder is configured to generate assignment information indicating which blocks belong to which group. The assignment information includes information indicating an index of a first block and information indicating a plurality of block identifiers. Each block identifier identifies a particular block associated with a group in a sequence of blocks of which said first block is a member. In another embodiment, the assignment information includes information indicating indices of blocks assigned to a respective group.

The encoder is configured to generating at least one datagram of a plurality of datagrams, each datagram including the set of measurements for a respective group.

Embodiments provide an apparatus for decoding data. The data including a plurality of blocks having been arranged into groups. Each block corresponding to a sub-region of the data. The apparatus includes a decoder configured to receive assignment information indicating assignments of blocks to a group and a set of measurements representing coded data for the blocks corresponding to the group. The decoder is configured to reconstruct the data for sub-regions corresponding to the blocks of the group based on the set of measurements and the assignment information.

The decoder is configured to receive at least a portion of the assignment information and the set of measurements in at least one of a plurality of datagrams, and each datagram includes header information which allows the datagram to be parsed independently.

The assignment information includes information indicating an index of a first block and information indicating a plurality of group identifiers, each group identifier identifying a particular group associated with a block in a sequence of blocks of which said first block is a member. In another embodiment, the assignment information includes information indicating indices of blocks assigned to a respective group.

### BRIEF DESCRIPTION OF THE DRAWINGS

Example embodiments will become more fully understood from the detailed description given herein below and the accompanying drawings, wherein like elements are represented by like reference numerals, which are given by way of illustration only and thus are not limiting of the present disclosure, and wherein:

FIG. 1 illustrates a communication network according to an embodiment;

FIG. 2 illustrates components of a source device and destination device according to an embodiment;

FIG. 3 illustrates a clustering operation according to an embodiment;

FIG. 4 illustrates a graphical representation of a plurality of feature vectors and a plurality of groups having assigned feature vectors according to an embodiment;

FIG. 5 illustrates a clustering operation according to another embodiment;

FIG. 6 illustrates a compressive sampling process that applies a set of measurement bases to a group of blocks to generate a set of measurements according to an embodiment;

FIG. 7 illustrates a datagram including the set of measurement according to an embodiment; and

FIG. 8 illustrates a reconstruction process for decoding the datagram including the set of measurements according to an embodiment.

### DETAILED DESCRIPTION OF EXAMPLE EMBODIMENTS

Various embodiments of the present disclosure will now be described more fully with reference to the accompanying drawings. Like elements on the drawings are labeled by like reference numerals.

As used herein, the singular forms “a”, “an”, and “the” are intended to include the plural forms as well, unless the context clearly indicates otherwise. It will be further understood that the terms “comprises”, “comprising,”, “includes” and/or “including”, when used herein, specify the presence of stated features, integers, steps, operations, elements, and/or components, but do not preclude the presence or addition of one or more other features, integers, steps, operations, elements, components, and/or groups thereof.

The embodiments will now be described with reference to the attached figures. Various structures, systems and devices are schematically depicted in the drawings for purposes of explanation only and so as not to obscure the present disclosure with details that are well known to those skilled in the art. Nevertheless, the attached drawings are included to describe and explain illustrative examples of the embodiments. The words and phrases used herein should be understood and interpreted to have a meaning consistent with the understanding of those words and phrases by those skilled in the relevant art. To the extent that a term or phrase is intended to have a special meaning, i.e., a meaning other than that understood by skilled artisans, such a special definition will be expressly set forth in the specification that directly and unequivocally provides the special definition for the term or phrase.

Co-pending application Ser. No. 12/894,757 filed Sep. 30, 2010, which is incorporated by reference in its entirety, discloses an apparatus and method that encodes acquired data (e.g., video, audio or image data) using compressive measurements to generate a set of measurements, which represents the acquired data. For example, an encoder determines a temporal structure based on a series of consecutive frames in the data such as one of a video cube and video tube. In other words, the encoder arranges the acquired video data into video cubes or video tubes. Then, the encoder encodes the video cubes or tubes using compressive sampling by applying a measurement matrix to the video cubes or tubes to obtain a set of measurements, which may be represented by a feature vector, for example. After a decoder receives the set of measurements, the decoder reconstructs the video data based on an optimization process that uses the set of measurements and the measurement matrix that was applied to the data at the encoder.

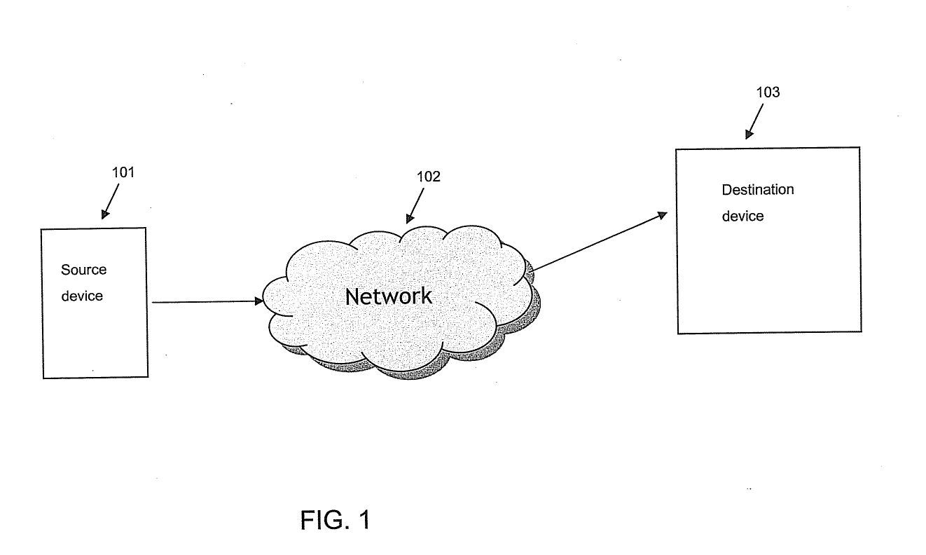

However, according to the embodiments of the present disclosure, the encoder employs a clustering operation that arranges the acquired data into a plurality of blocks, and assigns the plurality of blocks into clusters or groups. The term cluster may be considered synonymous with the term group. The encoder generates a set of measurements for each group using a measurement matrix and the values representing the group. Also, the encoder may generate assignment information that indicates the assignment of blocks to the groups. After receiving the set of measurement and the assignment information, the decoder reconstructs the encoded data based on an optimization process. These features are further explained below with respect to FIGS. 1-8.

FIG. 1 illustrates a communication network according to an embodiment. The communication network includes at least one source device 101 for acquiring, encoding and/or transmitting data such as video, audio and/or image data, a network 102 supporting a transmission application, and at least one destination device 103 for receiving, decoding and/or displaying the received data. The network 102 may be any known transmission, wireless or wired, network. For example, the network 102 may be a wireless network which includes a radio network controller (RNC), a base station (BS), or any other known component necessary for the transmission of data over the network 102 from one device to another device. In the case of video, the transmission application part of the network 102 may include Digital Video Broadcasting—Handheld (DVB-H), Digital Video Broadcasting—Satellite services to Handhelds (DVB-SH), Long Term Evolution (LTE) or evolved Multimedia Broadcast and Multicast Services (eMBMS), for example. One device may transmit information to another device via a dedicated or shared communication channel 250.

The source device 101 may be any type of device capable of acquiring data and encoding the data for transmission via the network 102 such as personal computer systems, camera systems, mobile video phones, smart phones, or any type of computing device that may connect to the network 102, for example. Each source device 101 includes at least one processor, a memory, and an application storing instructions to be carried out by the processor. The acquisition, encoding, transmitting or any other function of the source device 101 may be controlled by at least one processor. However, a number of separate processors may be provided to control a specific type of function or a number of functions of the source device 101. The implementation of the controller(s) to perform the functions described below is within the skill of someone with ordinary skill in the art.

The destination device 103 may be any type of device capable of receiving, decoding and displaying data such as personal computer systems, mobile video phones, smart phones or any type of computing device that may receive data from the network 102. The receiving, decoding, and displaying or any other function of the destination device 103 may be controlled by at least one processor. However, a number of separate processors may be provided to control a specific type of function or a number of functions of the destination device 103. The implementation of the controller(s) to perform in the functions described below is within the skill of someone with ordinary skill in the art.

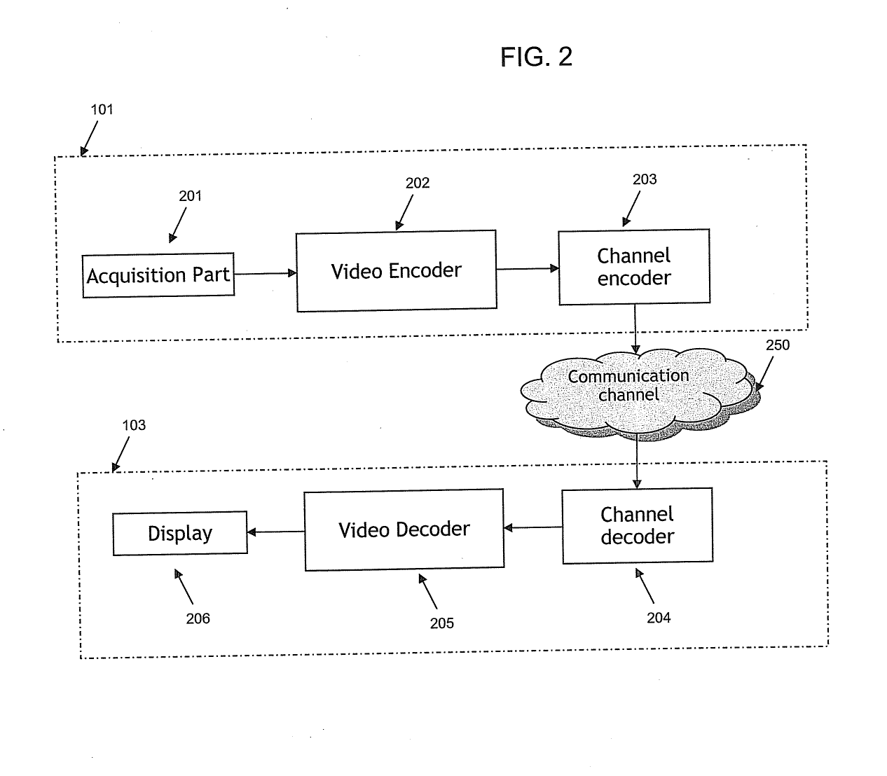

FIG. 2 illustrates components of the source device 101 and the destination device 103 according to an embodiment. For example, the source device 101 includes an acquisition part 201, a video encoder 202, and a channel encoder 203. In addition, the source device 101 may include other components that are well known to one of ordinary skill in the art. Referring to FIG. 2, in the case of video, the acquisition part 201 may acquire data from a video camera component included in the source device 101 or connected to the source device 101. Also, the source device 101 may acquire data from any type of computer-readable medium such as optical disks and/or any type of memory storage unit. The acquisition of data (video, audio and/or image) may be accomplished according to any well known methods. Although the below descriptions describes the encoding and decoding of video data, it is understanding that similar methods may be used for image data or audio data, or any other type of data that may be represented by a set of values.

According to an embodiment, the video encoder 202 encodes the acquired data using a clustering operation (e.g., unsupervised clustering operation) and compressive measurements to generate sets of measurements to be stored on a computer-readable medium such as an optical disk or storage unit or to be transmitted to the destination device 103. For example, the video encoder 202 arranges and assigns blocks of the data according to the clustering operation and applies a measurement matrix to the assigned blocks to generate sets of measurements, where each set corresponds to blocks of a different group.

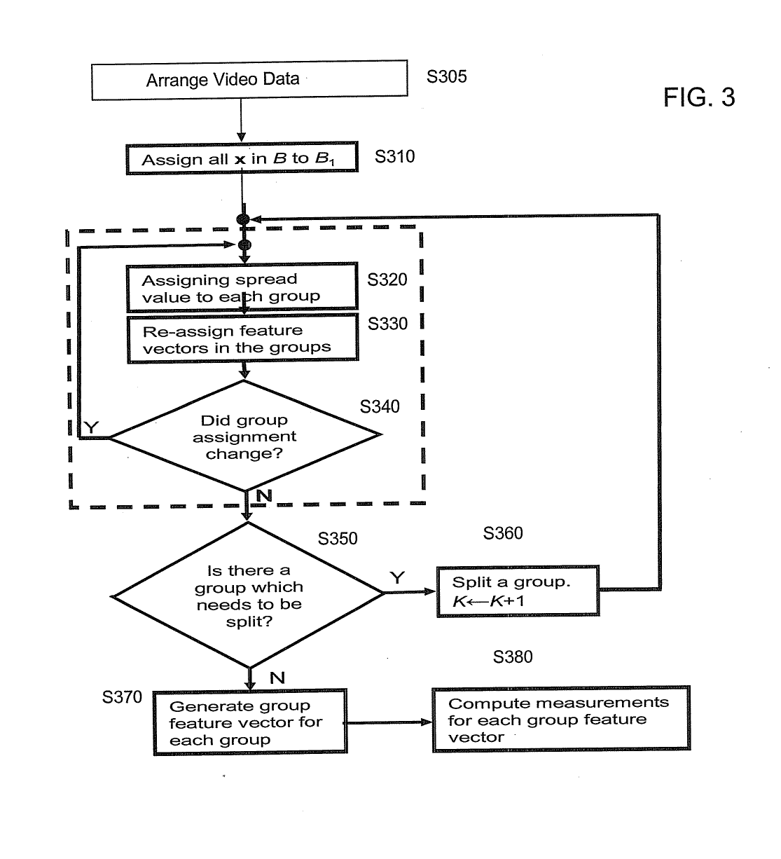

Further, the video encoder 202 may generate assignment information that indicates the assignments of the blocks to the groups. The video encoder 202 is further explained with reference to FIGS. 3-6. It is also possible to combine the functionality of the acquisition part 201 and the video encoder 202 into one unit, as described in co-pending application Ser. No. 12/894,855 filed Sep. 30, 2010, which is incorporated by reference in its entirety. Also, it is noted that the acquisition part 201, the video encoder 202 and the channel encoder 203 may be implemented in one, two or any number of units.

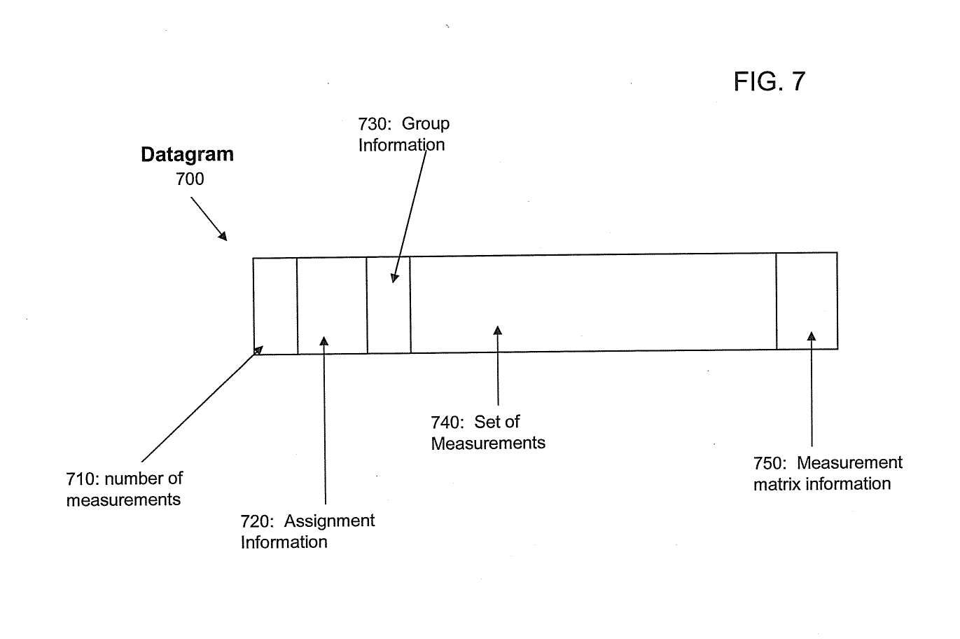

Using the set of measurements, the channel encoder 203 codes the measurements to be transmitted in the communication channel 250. For example, the channel encoder 203 may generate a plurality of datagrams that include the set of quantized measurements and assignment information. The channel encoder 203 may then transmit the datagrams to the destination device 203 or store the datagrams in a storage unit. The channel encoder 203 and the datagrams are further explained with reference to FIG. 7.

The datagrams may be further processed to include parity bits for error protection, as is well known in the art, before they are transmitted or stored.

The destination device 103 includes a channel decoder 204, a video decoder 205, and a video display 206. The destination device 103 may include other components that are well known to one of ordinary skill in the art.

The channel decoder 204 decodes the video data received from the communication channel 250. For example, the datagrams from the communication channel 250 are processed to detect and/or correct errors from the transmission by using the parity bits of the data. The correctly received packets are unpacketized to produce the quantized measurements and the assignment information generated in the video encoder 202. It is well known in the art that data can be packetized and coded in such a way that a received packet at the channel decoder 204 can be decoded, and after decoding the packet can be either corrected, free of transmission error, or the packet can be found to contain transmission errors that cannot be corrected, in which case the packet is considered to be lost. In other words, the channel decoder 204 is able to process a received packet to attempt to correct errors in the packet, to determine whether or not the processed packet has errors, and to forward only the correct measurements and assignment information from an error free packet to the video decoder 205.

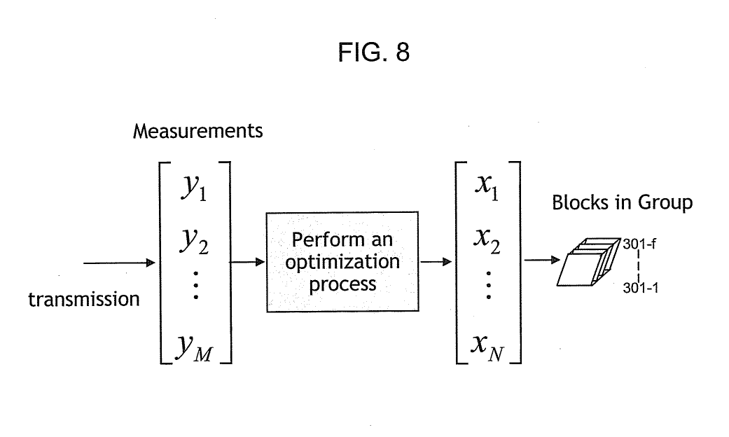

The video decoder 205 reconstructs the data for the blocks in a respective group, based on the set of measurements and the assignment information. For example, the video decoder 205 obtains information indicating the measurement matrix, which was applied at the video encoder 202 and performs an optimization process on the set of measurements using the obtained measurement matrix. The details of the video decoder 205 are further explained with reference to FIG. 8.

The display 206 may be a video display screen of a particular size, for example. The display 206 may be included in the destination device 103, or may be connected (wirelessly, wired) to the destination device 103. The destination device 103 displays the decoded video data on the display 206 of the destination device 103. Also, it is noted that the display 206, the video decoder 205 and the channel decoder 204 may be implemented in one or any number of units.

As indicated above, the video encoder 202 first performs a clustering operation, and then performs compressive sampling on the result of the clustering operation. However, before the details of the clustering operation in the context of compressive sampling are explained, a general discussion of a clustering operation is provided below.

One embodiment of a clustering operation includes unsupervised clustering. For example, in an unsupervised clustering operation, a finite set of vectors B are decomposed into K disjoint clusters B₁, . . . , B_{K} (B=∪ₖ₌₁^{K}Bₖ) such that the vectors in each cluster are, in some sense, similar to each other. Often, the motivation for this task is the assumption that the vectors in the finite set vectors B are samples from a mixture of unimodal distributions. The goal of clustering is to associate each vector with a specific distribution as a preliminary step for further analysis, for example, for estimation of the parameters of each distribution. The term “unsupervised” indicates no prior knowledge about the underlying distributions—e.g., the classification into clusters is done solely on the basis of the available vectors.

Usually the similarity between two vectors is measured by a distance function d(x,y) and the objective is to minimize the total of the spreads of each cluster. The spread of a cluster is a measure for the distance of the members of the cluster from each other, in the sense of the distance function d(x,y). A commonly used definition for the spread is the sum of the distances of the cluster members from the cluster's centroid, hence the objective is to minimize the total distance among the members of each cluster such that

$${\sum }_{k = 1}^{K} \vert \vert \{ d ( {c}_{k} , x ) \vert x ∈ {B}_{k} \} \vert \vert ,$$

where cₖ is the centroid of the k-th cluster. The centroid is a vector which is “at the center” of the cluster Bₖ (not necessarily a member of Bₖ). A more formal definition of a centroid is given below. The distance function d(x,y) is usually defined as a distance in a metric space, i.e. as a function which is:

Symmetric: d(x,y)=d(y,x) for any vectors x,y;

Positive: d(x,y)≧0 for any vectors x,y with an equality if and only if x=y; and/or

Satisfying the triangle inequality: d(x,y)≦d(x,z)+d(z,y) for any vectors x,y,z.

Depending on the application, the expression ∥{d₁, . . . , d_{L}}∥ is defined as the average, the sum or the maximum of the distances {d₁, . . . , d_{L}} or in any other suitable method. The centroid cₖ of the k-th cluster, is a vector which minimizes the expression ∥{d(cₖ,x)|xεBₖ}∥, which is the spread of cluster k. The spread indicates the level of dissimilarity among the members of the cluster. However, other embodiments may utilize alternative definitions distance which are not metrics or alternative definitions of a spread of a cluster, which are not based on notion of a centroid.

For the most part, algorithms used for unsupervised clustering are iterative. At the beginning of the iteration, the vectors in B are assigned to clusters B₁, . . . , B_{K} in a random or nearly random manner. Then, those assignments are corrected in subsequent iterations. Each iteration includes two steps: First, for each cluster Bₖ, k=1, . . . , K a centroid vector cₖ is computed, which minimizes ∥{d(cₖ,x)|xεBₖ}∥. Second, each vector x in B is reassigned to a cluster Bₖ for which the distance d(cₖ, x) is minimal. The next iteration begins by repeating the first step on the new cluster assignment.

Under fairly general conditions, this process converges to a local minimum of the objective function, that is, after several iteration each vector x is reassigned to the same cluster to which it was assigned in the previous iteration.

The number of clusters may be defined in advance, but often it is also determined heuristically based on the data. One may, for example, begin with the trivial case of a single cluster (B₁=B) and repeatedly increase the number of clusters by splitting the cluster with the largest spread and then iteratively optimize the cluster assignments. The process stops, for example, when the spread of all clusters is below a prescribed threshold.

One of the issues in determining the “right” number of clusters is the problem of outliers. An outlier is a vector in B which is far from any of the centroids. Letting the algorithm continue until the spread of every cluster is less than a threshold may lead to clusters with very few members, which can be a problem if the goal is to estimate parameters of the underlying distribution. Therefore, in many applications the splitting of clusters stops when the number of vectors in each cluster is below a certain number.

FIG. 3 illustrates a clustering operation in the context of compressive sensing according to an embodiment.

Steps S310-S360 describe a method by the encoder, which assigns a plurality of blocks into groups such that a spread value associated with each group meets a desired criterion.

Referring to FIG. 3, in S305, the video encoder 202 arranges the data acquired from acquisition part 201 into a plurality of blocks. The acquired data may be referred to as a video asset consisting of a sequence of video frames of a known width and height. Each block of the video asset may have the same size and shape. However, the embodiments also encompass blocks of different sizes. More so, each block of the video asset may be represented by a corresponding feature vector representing a corresponding sub-region of the acquired data (e.g., corresponding to a particular block). In the case of video, the feature vector may be referred as a pixel vector having the pixel values of the block. If the term pixel vector is used, it is understood that pixel vector may be replaced with feature vector in the case that the acquired data includes information other than video such as audio and/or images. Also, in S305, the video encoder 202 may perform signal processing on the plurality of blocks such as a Fourier transform to obtain the feature vectors of the plurality of blocks, where each feature vector includes a number of values representing a particular block or sub-region of the video asset. In the case of video, the pixel vector includes a number of pixel values representing a particular block or sub-region of the video asset.

In S310, initially, the video encoder 202 assigns each block to one group. Because a pixel vector represents a corresponding block, it can also be said that the video encoder 202 assigns each pixel vector to one group, as further described below. In other words, an assignment of a pixel vector to a group refers to an assignment of a block to a group. In S310, the video encoder 202 may initially assign all pixel vectors to group B₁.

In S320, the video encoder 202 assigns a spread value to each group. For example, initially, the video encoder 202 assigns the spread value to group B₁. However, after one or more iterations, the video encoder 202 re-assigns a spread value to each group. The spread value indicates the level of dissimilarity or similarity among the members of the group. The embodiments encompass any type of mechanism that measures the level of dissimilarity/similarity among the members of a group. In one particular example, the spread value may be based on distances from a centroid vector. As such, the video encoder 202 computes the centroid vector Cₖ, where k=1, . . . , K, and a value of K is the total number of groups. The centroid vector of a particular group is a vector which is at the center of the group (e.g., not necessarily a member of the group). The video encoder 202 computes the centroid vector for each group based on a distance function. For instance, for each group Bₖ, the video encoder 202 computes the centroid Cₖ such ∥d(c_{K}, x)|xεBₖ∥ is minimized.

Based on the above-equation, the video encoder 202 computes the centroid vector such that the average, the sum or the maximum of the distances between each pixel vector within each group and the respective centroid vector is minimized.

In S330, the video encoder 202 may reassign each pixel vector to a group such that a spread value associated with each group meets a desired criterion. For example, the video encoder 202 reassigns the blocks or pixel vectors to reduce the spread value for each centroid vector. The video encoder 202 reassigns each pixel vector to a group Bₖ for which the distance d(cₖ,x) is minimal, for example, xεBₖ if k=arg min d(cₖ, x)|k=1, . . . , K , as explained above. By the video encoder 202 minimizing the spread value for each group, the pixel vectors within each group have at least one similar feature, which is the distance from the pixel vector to the centroid of the group.

In S340, if the video encoder 202 reassigns the pixel vector to a new group to minimize or reduce the spread value, the video encoder 202 repeats steps S320 and S330 to recalculate the spread value (e.g., centroid vector for each group).

In S350, the video encoder 202 determines whether to split one of the groups into at least two groups. More so, the number of groups may be defined, arranged or determined in advance. However, the number of groups may also be determined based on the spread values for each centroid vector within for each group and/or the number of pixel vectors within each group.

More specifically, the video encoder 202 may split the group with the largest spread value into at least two groups until the spread of each group is below a first threshold. Further, the video encoder 202 may split at least one of the groups if an amount of pixel vectors within at least one group is above a second threshold. Thus, at least one of the groups may be split based on the first threshold and/or the second threshold. The first threshold may be a distance measurement so that the spread value for each group is below a calculated or specified amount. The second threshold may be a counter so that total number of pixel vectors within each group is below a calculated or specified amount.

Further, if the video encoder 202 determines to split at least one group in S350, in S360 the video encoder 202 splits the at least one group into at least two groups. Further, if the at least one group is split into at least two groups in S360, the video encoder 202 may re-determine the centroid vector for each group and the group assignments in S320 and S330. This process may be repeated until the spread value for each group is minimized.

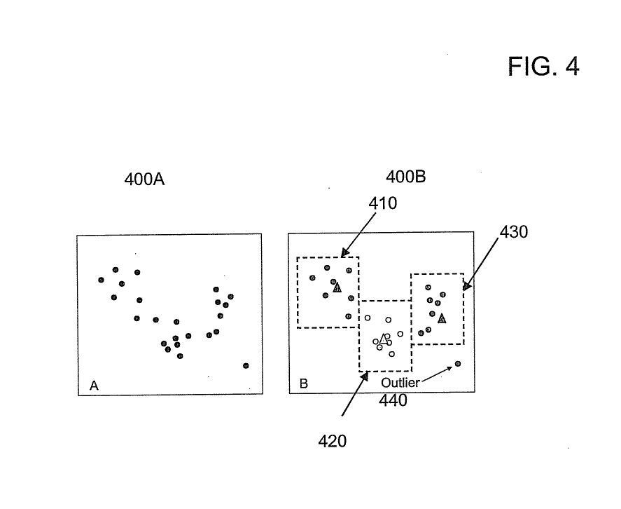

FIG. 4 illustrates a graphical representation of a plurality of pixel vectors and a plurality of groups having assigned pixel vectors according to an embodiment.

FIG. 4, element 400A illustrates pixel vectors representing sub-regions of the data pre-assignment to the groups. In relation to FIG. 3, FIG. 4, element 400A may illustrate the pixel vectors before the initializing in S310 of FIG. 3.

FIG. 4, element 400B illustrates the same pixel vectors as element 400A, however the pixel vectors in element 400B are assigned to three different groups, 410, 420 and 430, as determined by steps S310-S340 of FIG. 3. More so, each of the three groups 410-430 have a triangle corresponding to the centroid vector of each of the three groups 410-430.

Furthermore, 400B illustrates a data outlier 440. The outlier 440 is a pixel vector that may be formally assigned to one of the plurality of groups, but is so far away from a centroid vector that the assignment may be meaningless. In other words, the outlier 440 may be a pixel vector that is far away from any of the other centroid vectors.

Referring back to FIG. 3, in S370, the video encoder 202 generates a group pixel vector for each group of pixel vectors. Further, the group pixel vector for each group may be based on each pixel vector within a respective group. More specifically, the video encoder 202 concatenates (e.g., adds) the pixel vectors of each block within each group to form the group pixel vector. The video encoder 202 determines the order of concatenation based on the relation between the blocks represented by the pixel vectors.

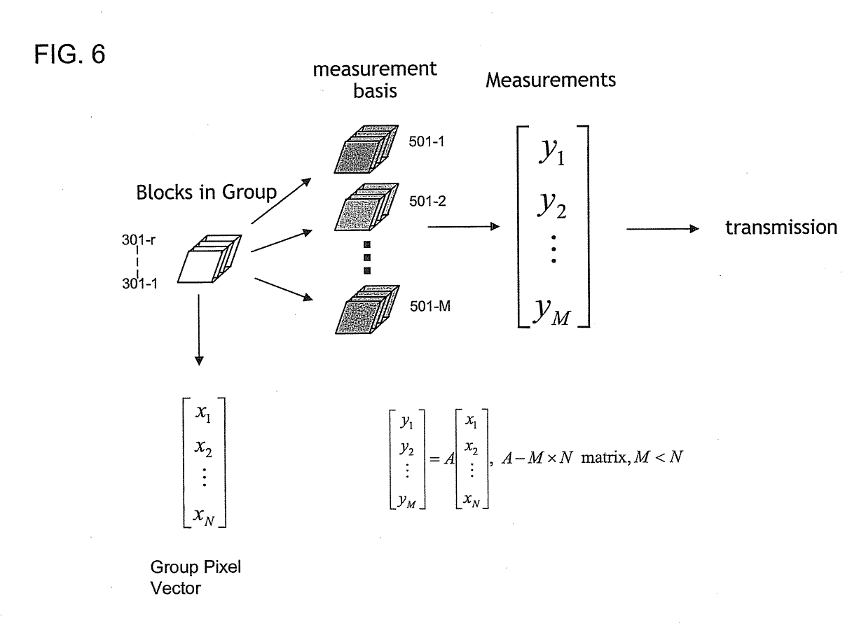

In step S380, the video encoder 202 generates a set of measurements for a particular group pixel vector by applying a measurement matrix to the respective group pixel vector, as further explained with reference to FIG. 6.

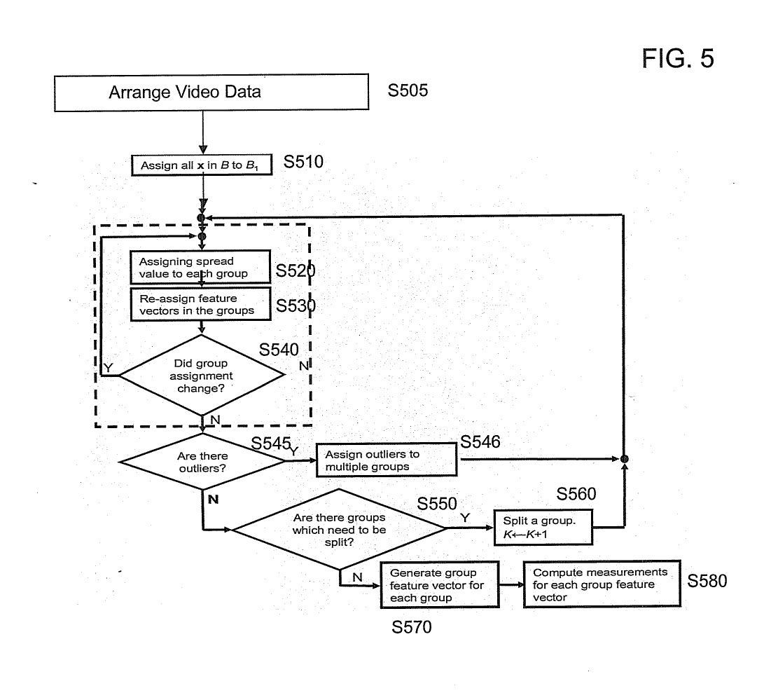

FIG. 5 illustrates a clustering operation according to another embodiment.

S505-S540 and S550-S580 in FIG. 5 correspond to S305-S340 and S350-S380 of FIG. 3, respectively. Accordingly description of these steps will be omitted for the sake of brevity.

In S545, the video encoder 202 may determine if one of the pixel vectors is an outlier with respect to the other pixel vectors within a group. As discussed above, with reference to FIG. 4, 400B the video encoder 202 may determine an outlier if a distance from the pixel vector to any centroid vector is above a first threshold representing a specified distance.

If the video encoder 202 determines in S545 that a pixel vector is an outlier, in S546, the video encoder 202 may assign the outlier pixel vector to multiple groups. Accordingly, the clustering technique used is “soft” because some pixel vectors belong to multiple groups.

More specifically, the video encoder 202 may determine that the distance d(cₖ,x) from a pixel vector X to a centroid cₖ is above the first threshold, the video encoder 202 may determine that the pixel vector X is an outlier pixel vector. An outlier pixel vector may be a pixel vector that is on a boundary between two centroids c₁ and c₂. Therefore, the video encoder 202 may represent the outlier pixel vector by two vectors x_{1 and} x₂. The video encoder 202 may assign the pixel vector to the two centroids c₁ and c₂ to minimize d(c₁,x₁) and d(c₂,x₂) such that x=x₁+x₂.

When decoding the encoded data, the video decoder 205 may determine that the outlier pixel vector belongs to multiple groups, and the video decoder 205 may add the distances from the outlier pixel vector to each respective centroid vector to obtain the correct pixel vector. More specifically, the video decoder 205 may decode the outlier pixel vector such that d(c₁,x₁) is associated with the centroid c₁, and may decode the outlier pixel vector such that d(c₂,x₂) is associated with the centroid

FIG. 6 illustrates a compressive sampling process that applies a set of measurement bases to a group of blocks to generate a set of measurements according to an embodiment.

Referring to FIG. 6, blocks 301-1 to 301-r corresponding to a particular group, where a value of r is the number of blocks included in the group. Group pixel vector [x₁ x₂ . . . x_{N}] represents the values of the blocks in the group (e.g., the collection of pixel vectors in one group), and a value of N indicates the number of pixel values in the group, pixel vector.

The video encoder 202 applies a set of measurement bases 501-1 to 501-M to the blocks 301 to obtain a set of measurements y₁ to y_{M}. The value of M may be any integer greater or equal to 1. Each value of y represents a compressive measurement. A number of measurement bases M applied to the blocks 301 corresponds to a number of measurements M. A description of how compressive measurements are calculated is explained below.

First, the video encoder 202 scans the pixels of the blocks 301 to obtain group pixel vector xε [symbol] ^{N}, which is a one dimensional (1-D) representation of the blocks 301 including the video data. The group pixel vector x includes the pixel values of the blocks 301, which is arranged as [x₁ x₂ . . . x_{N}]. As shown in FIG. 6, the group pixel vector x may be multiplied by measurement matrix A to obtain the set of measurements y₁ to y_{M}. The measurement matrix A includes an assigned pattern of values. Each row of the measurement matrix A represents a separate measurement basis. For instance, the measurement matrix A is graphically represented by the set of measurement bases 501-1 to 501-M. The measurement matrix A may be interchangeably used with the set of measurements 501-1 to 501-M. The length of vector x is N, which is also the number of pixels in the blocks 301. As such, the M compressive measurements of vector x is the vector yε [symbol] ^{M} defined by y=Ax. Measurement matrix A has dimension M×N, where M is the number of measurements, and N is the length of the vector x, i.e., N is the number of pixels in the blocks 301.

The values of the measurement matrix A may be constructed using a randomly permutated Walsh-Hadamard matrix. However, the embodiments encompass any type of matrix for use as the measurement matrix A. Further, the measurement matrix may be generated according to another method, as further explained in co-pending application Ser. No. ______ concurrently filed herewith [attorney docket No. 29250-002540], which is incorporated by reference in its entirety.

The video encoder 202 generates a set of measurements for each of the group pixel vectors, where each set of measurements corresponds to a different group. Further, each measurement may be further quantized by using a method that is well known to one of ordinary skill in the art.

Then, the video encoder 202 generates assignment information for each group pixel vector. More specifically, the assignment information may identify the group that each of the blocks is respectively assigned. In the case of an outlier pixel vector, the outlier pixel vector may be assigned to multiple groups.

The video encoder 202 outputs each set of measurements for the groups and the generated assignment information to the channel encoder 203. The channel encoder 203 generates a plurality of datagrams that include the set of measurements for each group and the assignment information. A datagram is a basic unit in which coded information is packed. Also, a datagram may correspond to a unit of a transmission protocol, such as the user datagram protocol (UDP) and the like, for example. However, the datagrams of the present disclosure need not be associated with any particular transmission protocol.

Then, the channel encoder 203 transmits the plurality of datagrams to the destination device 103 or stores them in a storage unit

FIG. 7 illustrates a datagram 700 including the set of measurement according to an embodiment. Each datagram may correspond to a set of measurements, or a portion of the set, for one particular group. In other words, all the measurements in the same datagram correspond to the same group. The measurement may have been quantized by using a method well known in the art.

The datagram 700 may include information 710 indicating a number of measurements included in the datagram 700, assignment information 720, group information 730, the set of measurements 740, and/or measurement matrix information 750. The assignment information 720 includes information indicating the assignment of blocks (pixel vectors) to the group. The assignment information 720 is further explained below. The group information 730 includes information indicating a number of blocks (e.g., a number of pixel vectors) included in the datagram 700. Further, the group information 730 may include information indicating a group identifier field which specifies the group to which the measurements correspond. The measurement matrix information 750 includes information indicating the identity of the measurement matrix that was applied at the encoder. Based on the measurement matrix information 750, the decoder may reconstruct the measurement matrix. For example, the measurement matrix information 750 may include information indicating a dimension of the measurement basis, which may be the number of pixel vectors in the group, and information indicating a seed for a random number generator. Therefore, based on the dimension and the seed, the decoder may obtain the measurement matrix that was applied at the encoder. In addition, although not shown, each datagram includes header information which allows the datagram to be parsed independently.

The datagram 700 is not required to include all of the above information. For example, if the number of measurements in a datagram is fixed, the datagram 700 may not include the information 710 indicating a number of measurements. Furthermore, the group information 730 and the measurement matrix information 750 may be omitted depending on the application. Furthermore, a portion or all of the assignment information 720, as further described below, may be included in a particular datagram.

The channel encoder 203 may generate each datagram to include a strong error detection code and if an error is detected at the decoder the datagram is discarded. Therefore, effectively, a datagram is either received correctly or lost.

According to an embodiment, the coding scheme of the present disclosure is designed so that even if a portion of the datagrams is lost, decoding is possible with some acceptable degradation. However, there is a minimal reception rate below which any attempt to perform in decoding is futile. In this case, the minimal reception rate may be referred to as the critical ratio of datagram reception. Depending on the organization of the datagrams, the critical ratio may apply to the asset as a whole or to individual groups. In the latter case, if the fraction of datagrams received for a particular group is below the critical ratio, the video for that group should not be decoded and pixel values of the blocks of that group may be synthesized using some heuristic method, e.g. by extension of neighboring groups.

The assignment information 720 is a mapping between the blocks and the group identifiers. In one embodiment, the assignment information 720 may include information representing a table indexed by block indices (Table 1), where each entry contains the group identifier of the corresponding block. Table 1 is reproduced below.

TABLE 1

| | 1 | 2 | 3 | 4 | 5 |
|---|---|---|---|---|---|
| A | α | α | β | α | β |
| B | α | β | β | β | γ |
| C | β | γ | β | γ | γ |
| D | β | γ | γ | γ | γ |

In another embodiment, the assignment information 720 may include, for each group, information indicating a list (Table 2) of the block indices of the blocks in the group. Table 2 is illustrated below.

TABLE 2

| | |
|---|---|
| α | A1, A2, A4, B1 |
| β | A3, A5, B2, B3, B4, C1, C3, D1 |
| γ | B5, C2, C4, C5, D2, D3, D4, D5 |

The assignment information 720, represented in both table 1 and table 2, identifies each block (e.g., A1, A2, B5, C2, etc.) as being assigned to one of 3 groups represented by the Greek letters α, β and γ.

Using the method associated with table 1, the assignment information 720 may include information indicating an index (A1) of a first block (which is represented by a pixel vector) and a list of group identifiers (e.g., α, β, α, β). Further, the assignment information 720 may include information indicating the order of group identifiers. For example, the list of group identifiers may follow a predefined pattern. In particular, the list of group identifiers which starts from that first block (A1) and continues in a predefined order (e.g., going to the next block on the right and when reaching the end of the row moving to the leftmost block one row lower). As such, the information indicating the order of group identifiers provides information on how the next group identifier matches a respective block index. This list of group identifiers may be further compressed by using run length coding.

Using a second method associated with table 2, the assignment information 720 may include information indicating indices of blocks assigned to a respective group. Further, the assignment information 720 may include information indicating the indices of the blocks assigned to a respective group such that the indices are arranged in a sequence in such a way that the “city block distance” (e.g., sum of distances along each dimension) between consecutive blocks is minimal. Further, in another embodiment, the first element in the list of indices may be provided in full, however, the rest of the elements in the list of indices may be specified as offsets from the previous elements.

According to another embodiment, each datagram may not include the assignment information 720. For example, the assignment information 720 may be provided in one datagram, and the subsequent datagrams corresponding to the same group of the datagram that included the assignment information 720 may omit the assignment information 720. Still further, a portion of the assignment information 720 may be provided in a datagram. For example, the assignment information 720 may include only the assignment information relating to the set of measurements included in the datagram. However, the embodiments encompass any type of arrangement for the transmission of assignment information.

The channel encoder 203 may perform variable length coding of the parameters after the distribution of the values of the parameters are known, by applying coding techniques such as Huffman coding or arithmetic coding. These techniques assign fewer bits to statistically frequent values and thus reduce the data rate, bringing it closer to the entropy rate. Thus, for example, for random or random-like measurement bases, the measurements have a distribution which is very close to Gaussian distribution. This fact may be used to code the measurements with significantly fewer bits than would be necessary if each measurement was represented by the same number of bits.

Much of the data described above is in the form of sets with no particular order among members. Therefore, according to an embodiment, selecting a suitable order may make variable length coding even more effective. For example, the group identifiers may be sorted by decreasing number of blocks in the group and group identifiers are coded so that identifiers of large groups require fewer bits than identifiers of small groups. Similarly, if the second method (Table 2) of representing the clustering structure, sorting the indices of the blocks in the group so that the “city block distance” between consecutive indices is minimal allows effective variable length coding of the step between elements in the sequence.

Next, the source device 101 may transmit the plurality of datagrams to the destination device 103 via the communication channel 250 of the network 102.

The channel decoder 204 of the destination device 101 decodes the received datagrams. The channel decoder 205 may use the header information in the datagrams to independently parse each datagram. The channel decoder 205 forwards the correctly received, parsed datagrams including the set of measurements and the other information of the datagram to the video decoder 205 so that the video decoder 205 can reconstruct the video data, as further explained below.

FIG. 8 illustrates a reconstruction process for decoding the datagram including the set of measurements according to an embodiment.

The video decoder 205 calculates the pixel values [x₁, . . . , x_{N}] corresponding to a particular group pixel vector according to a minimization equation that uses the received set of measurement, and an obtained measurement matrix, as further explained below.

For example, the video decoder 205 solves one of the following minimization equations for the pixel values of the reconstructed group pixel vector, which is performed by a minimization of two-dimensional (2D) total variation (e.g., a TV function) of 1-dimensional (1D) DCT coefficients in the time domain:

$$\begin{matrix}{min}_{x} {TV}_{2} ( {DCT}_{t} ( x ) ) , subject to y = Ax , or & Equation 1 \text{:} \\ {min}_{x} {TV}_{2} ( {DCT}_{t} ( x ) ) + \frac{μ}{2} \vert \vert Ax - y {\vert \vert}_{2}^{2} & Equation 2 \text{:}\end{matrix}$$

In both equations, y is the set of available transmitted measurements, i.e., y₁ to y_{N}, and A is the measurement matrix representing the set of measurement bases, i.e., 501-1, 501-N, and x is the vector [x₁ x₂ . . . xₘ], whose components are pixels of the blocks 301. The video decoder 205 obtains the measurement matrix A that was applied to the video data at the video encoder 202 based on the measurement information, as described above. The variable μ is the penalty parameter. The value of the penalty parameter is a design choice. DCTₜ(x) is a 1-D DCT transform in the time domain, and TV₂(z) is a 2-D total variation function, where z represents the results of the 1-D DCT function. Equation 2 is an alternative way of expressing Equation 1. However, the video decoder 205 may implement either Equation 1 or Equation 2 according to methods that are well known.

The video decoder 205 solves the minimization problem of Equation 1 or Equation 2 to obtain the pixel group vector [x₁ x₂ . . . x_{N}]. For example, the video decoder 205 reconstructs the video data according to the total variation (TV) of a discrete cosine transform (DCT) coefficients of candidate video data. The candidate video data is based on the measurement matrix A and the received measurements. For example, in y=Ax, the received measurements y and the measurement matrix A are known. As such, the minimization problem solves for values of x (e.g., the pixel group vector x), for which the resulting values of the pixel group vector x are the minimum values of a total variation (TV₂) function of a discrete cosine transform (DCT) function. The creation of Equation 1 and Equation 2 is further described below.

More generally, the minimization problem may also be characterized as: Equation 1:

$${min}_{x} Φ ( x ) subject to y = Ax ,$$

Equation 2 (which have equivalents to Equations 1 and 2 above):

$${min}_{x} Φ ( x ) + \frac{μ}{2} \vert \vert Ax - y {\vert \vert}_{2}^{2}$$

Φ(x) represents the choice of a regularization term and μ is the penalty parameter. If the vector x is sparse, Φ(x) may be chosen as the l₁-norm of a representation of the vector x in which x is sparse. However, when the vector x includes pixel values of the video data 403, it may not be apparent in which basis x is sparse, and further, in which basis, x has the most sparseness.

Embodiments of the present invention use the minimum spatial total variation of time domain DCT coefficients of the original video cube as the regulation term, which is provided in the following equation Φ(x)=TVₛ(DCTₜ(x)). DCTₜ(x) represents the pixel wise DCT in the temporal direction, and it is a cube in which each frame includes DCT coefficients of a particular frequency.

This process is further explained in application Ser. No. 12/894,807. Also, the video decoder 205 may include a TV minimization solver (TVAL3) for solving Equation 1 or Equation 2, which is also further explained in co-pending application Ser. No. 12/897,807 filed Sep. 30, 2010, which is incorporated by reference in its entirety, as well as further described in co-pending application Ser. Nos. 12/894,855, and 12/894,757.

Referring to FIG. 8, after the values of the pixel group vector x are obtained, the video decoder 205 re-assembles the blocks 301 based on the assignment information.

For example, the blocks 301 can be formed from the pixel group vector x by taking the components of x to fog the pixels of the blocks column by column and then block by block. However, the embodiments encompass any type of method that reconstructs video blocks (or a particular structure of a video frame such as video cubes or tubes) from a set of values. This process must be exactly the inverse of the process in which the vector x is formed from the video frame when the measurements are made.

The destination device 103 displays the video data or a portion thereof on the video display 206.

Variations of the example embodiments are not to be regarded as a departure from the spirit and scope of the example embodiments, and all such variations as would be apparent to one skilled in the art are intended to be included within the scope of this disclosure.

What is claimed:

1. A method for encoding data, the method comprising:
arranging, by an encoder, data into a plurality of blocks, each block corresponding to a sub-region of the data;
assigning, by the encoder, the plurality of blocks into groups such that a spread value associated with each group meets a desired criterion, the spread value indicating a level of dissimilarity or similarity among members of a group; and
generating, by the encoder, a set of measurements for at least one group of blocks, the set of measurements being coded data representing the blocks corresponding to the at least one group.

2. The method of claim 1, wherein the assigning step assigns one block of the plurality of blocks to two groups.

3. The method of claim 1, further comprising:
generating, by the encoder, assignment information indicating which blocks belong to which group.

4. The method of claim 3, wherein the assignment information includes information indicating an index of a first block and information indicating a plurality of group identifiers, each group identifier identifying a particular group associated with a block in a sequence of blocks of which said first block is a member.

5. The method of claim 3, wherein the assignment information includes information indicating indices of blocks assigned to a respective group.

6. The method of claim 1, further comprising:
generating, by the encoder, at least one datagram of a plurality of datagrams, each datagram including the set of measurements for a respective group.

7. A method for decoding data, the data including a plurality of blocks having been arranged into groups, each block corresponding to a sub-region of the data, the method comprising:
receiving, by a decoder, assignment information indicating assignments of blocks to a group and a set of measurements representing coded data for the blocks corresponding to the group; and
reconstructing, by the decoder, the data for sub-regions corresponding to the blocks of the group based on the set of measurements and the assignment information.

8. The method of claim 7, wherein the receiving step receives at least a portion of the assignment information and the set of measurements in at least one of a plurality of datagrams, and each datagram includes header information which allows the datagram to be parsed independently.

9. The method of claim 7, wherein the assignment information includes information indicating an index of a first block and information indicating a plurality of group identifiers, each group identifier identifying a particular group associated with a block in a sequence of blocks of which said first block is a member.

10. The method of claim 7, wherein the assignment information includes information indicating indices of blocks assigned to a respective group.

11. An apparatus for encoding data, the apparatus comprising:
an encoder configured to arrange data into a plurality of blocks, each block corresponding to a sub-region of the data,
the encoder configured to assign the plurality of blocks into groups such that a spread value associated with each group meets a desired criterion, the spread value indicating a level of dissimilarity or similarity among members of a group, and
the encoder configured to generate a set of measurements for at least one group of blocks, the set of measurements being coded data representing the blocks corresponding to the at least one group.

12. The apparatus of claim 11, wherein the encoder assigns one block of the plurality of blocks to two groups.

13. The apparatus of claim 11, wherein the encoder is configured to generate assignment information indicating which blocks belong to which group.

14. The apparatus of claim 13, wherein the assignment information includes information indicating an index of a first block and information indicating a plurality of group identifiers, each group identifier identifying a particular group associated with a block in a sequence of blocks of which said first block is a member.

15. The apparatus of claim 13, wherein the assignment information includes information indicating indices of blocks assigned to a respective group.

16. The apparatus of claim 11, wherein the encoder is configured to generate at least one datagram of a plurality of datagrams, each datagram including the set of measurements for a respective group.

17. An apparatus for decoding data, the data including a plurality of blocks having been arranged into groups, each block corresponding to a sub-region of the data, the apparatus comprising:
a decoder configured to receive assignment information indicating assignments of blocks to a group and a set of measurements representing coded data for the blocks corresponding to the group, and
the decoder is configured to reconstruct the data for sub-regions corresponding to the blocks of the group based on the set of measurements and the assignment information.

18. The apparatus of claim 17, wherein the decoder is configured to receive at least a portion of the assignment information and the set of measurements in at least one of a plurality of datagrams, and each datagram includes header information which allows the datagram to be parsed independently.

19. The apparatus of claim 17, wherein the assignment information includes information indicating an index of a first block and information indicating a plurality of group identifiers, each group identifier identifying a particular group associated with a block in a sequence of blocks of which said first block is a member.

20. The apparatus of claim 17, wherein the assignment information includes information indicating indices of blocks assigned to a respective group.
